(19) United States
(12) Patent Application Publication
(10) Pub. No.: US 2023/0209020 A1
(43) Pub. Date: Jun. 29, 2023

(54) EAR-WORN ELECTRONIC DEVICE AND METHOD PERFORMED BY THE EAR-WORN ELECTRONIC DEVICE

(71) Applicant: HUAWEI TECHNOLOGIES CO., LTD., SHENZHEN (CN)

(72) Inventor: Carlos Emanuel MORALES ESPINOZA, Tokyo (JP)

(21) Appl. No.: 18/170,786

(22) Filed: Feb. 17, 2023

Related U.S. Application Data
(63) Continuation of application No. PCT/CN2020/110301, filed on Aug. 20, 2020.

(51) Int. Cl. H04N 7/18; G06F 1/16

(52) U.S. Cl. CPC H04N 7/185; G06F 1/163

(57) ABSTRACT

Provided is a camera-enabled ear-worn device with systems and methods that extend the user’s view. An electronic device configured to be worn on an ear of the user includes a sensor configured to detect first information about a surrounding of the user, the first information including second information about an area beyond a field of view of the user. The electronic device also includes a processing unit configured to carry out an operation associated with the first information. In an embodiment, the electronic device further includes a communication device configured to communicate with another electronic device.

### CROSS REFERENCE TO RELATED APPLICATIONS

This application is a continuation of International Application No. PCT/CN2020/110301, filed on Aug. 20, 2020, the disclosure of which is hereby incorporated by reference in its entirety.

### TECHNICAL FIELD

Embodiments of the present application relate to an ear-wearing type electronic device and a method performed by it, and in particular, to an ear-wearing type electronic device which provides extended vision to a user and a method of providing extended vision to the user using the ear-wearing type electronic device.

### BACKGROUND

Computer vision technology is one of Artificial Intelligence (AI) technologies used for image recognition, motion tracking and image data extraction. It allows a computing system to automatically identify objects in individual pictures or frames of video, or to recognize human activity over a series of video frames. It provides high-level understanding of the real world via computer vision tasks such as scene understanding, 3D perception, gesture recognition, etc. from images captured by a camera (e.g., RGB camera, Event camera, IR camera). For example, the computer vision can be used for determining the position of a person’s face in a digital image.

The computer vision will define the next innovation on wearables. Indeed, many companies have recently started to put efforts on development of hardware and software that can run computer vision tasks on a computer device at extremely low power.

This technology will enhance practical application of new always-on, camera-enabled smart devices that can understand the user’s environment in the near future.

On the other hand, earwear devices such as earphones, earbuds, and headphones are popular consumer devices nowadays. In the course of such progress of the computer vision technology, earwear incorporating a camera are being developed. For example, an earwear with camera facing to the user is well known. This device uses optical sensors to check ear presence and/or monitor the user’s heart rate.

Also, an earwear with camera facing to the world is known. This technology may use the camera in the earwear to take pictures and/or record videos of the user’s environment. For example, images captured by the camera in the headset can be wirelessly transmitted to the user’s mobile device which has motion or location sensors. The images and the information provided by the mobile device are used to estimate the user’s location. Further navigation feedback to the user is given by audio on the headset or vision on the mobile device.

Also, it can have a function of video recording and processing such as compress video, basic image processing and video transfer to another device like user’s phone. This enables some further feedback to user.

Further, the earwear with camera can be used for pattern recognition, gesture recognition, 3D recognition of goods and objects, 3D scanning and 3D photography.

However, the conventional camera-equipped earphones and headsets are only used as auxiliary devices for information devices such as computers and mobile phones. The information of images acquired by the camera function are immediately transmitted to these information devices and processed therein. Therefore, the earphone or headset may be connected to the information device by wire or wirelessly for communication.

Also, the camera incorporated in the conventional earphones or headsets only acquire images within the range of the field of view of the user in real time. Therefore, prior camera-enabled earwear devices do not extend the user’s field of view.

In addition, the camera incorporated in the conventional earphones or headsets does not provide real-time interaction with the user. It does not perform computer vision tasks on the device in real time but only handle a single computer task, and lack interaction/feedback between a user and an earpiece.

As described above, prior camera-enabled earwear has limited field of view, performs limited computer vision tasks. Also, it does not run the computer vision task in real time, and lacks interaction with or feedback to a user based on such computer vision tasks.

### SUMMARY

It is an object of the present disclosure to provide a camera-enabled earwear with systems and methods that extends the user’s view.

Another object of the present disclosure is to perform real-time and on-board processing of several computer vision tasks that understand the user and his/her environment.

Still other object of the present disclosure is to provide user-and-earwear interaction/feedback based on the user and environment understanding if necessary.

A first aspect of the present disclosure provides an ear-wearing type electronic device, the device comprising:

a sensor configured to detect first information about user’s surrounding, the first information including second information about an area beyond a field of view of a user wearing the ear-wearing type electronic device; and

a processing unit configured to carry out an operation associated with the detected information.

According to this embodiment, the ear-wearing type electronic device comprises a sensor configured to detect first information which includes second information about an area beyond a field of view of a user wearing the ear-wearing type electronic device. Also, a processing unit is configured to carry out an operation associated with the detected information. Therefore, it is possible to extend the user’s vision by the ear-wearing type electronic device.

With respect to a possible embodiment of the first aspect, the ear-wearing type electronic device further comprises:

a communication means configured to communicate with another ear-wearing type electronic device.

According to this embodiment, it is possible to complement a user’s field-of-view by using a pair of the ear-wearing type electronic devices.

With respect to a possible embodiment of the first aspect, wherein the first information is an image, and wherein the sensor includes a first imaging device and a second imaging device, and wherein the first imaging device captures the image such that the captured image does not overlap another image captured by the second imaging device.

A camera mounted on the earwear may have a limited field-of-view. Therefore, it is possible to effectively capture images by configuring the sensor to capture the image such that the captured image does not overlap another image captured by another ear-wearing type electronic device.

With respect to a possible embodiment of the first aspect, the detected information is an approaching object, and the operation includes alerting the user about the approaching object.

According to this embodiment, the ear-wearing type electronic device may interact with the user by alerting him/her when there’s a nearby car detected by a computer vision task.

With respect to a possible embodiment of the first aspect, the detected information is the user’s gesture, and the operation includes processing associated with the gesture.

According to this embodiment, the ear-wearing type electronic device can interact with the user by detecting gestures of the user using a camera mounted on the device.

With respect to a possible embodiment of the first aspect, the detected information is a location, and the operation includes guidance to a destination.

According to this embodiment, guidance to the user is given by audio on the headset or vision on the mobile device. Such guidance may include navigation feedback.

With respect to a possible embodiment of the first aspect, the detected information is a location, and the operation includes playing a media content associated with the detected location.

According to this embodiment, the ear-wearing type electronic device may use characteristics of surroundings of a user in order to play a media content such as music to the user based on the detected characteristics of the environment.

With respect to a possible embodiment of the first aspect, the detected information is a location, and the operation includes providing recommendation of contents to the user.

According to this embodiment, the ear-wearing type electronic device may use user’s gestures in order to operate the device.

With respect to a possible embodiment of the first aspect, the detected information is a location, and the operation includes:
accessing an external server to acquire information about the detected location; and
providing the user with the acquired information.

According to this embodiment, the ear-wearing type electronic device may use a location of a use in order to recommend media content to the user.

With respect to a possible embodiment of the first aspect, the ear-wearing type electronic device further comprises a haptic device configured to carry out notification associated with the detected information.

According to this embodiment, the haptic device can be used for carrying out notification associated with the detected information.

A second aspect of the present disclosure provides a method performed by an ear-wearing type electronic device comprising:
detecting first information about user’s surrounding, the first information including second information about an area beyond a field of view of a user wearing the ear-wearing type electronic device; and
carrying out an operation associated with the detected information.

With respect to a possible embodiment of the second aspect, the detecting operation comprises:

communicating with another ear-wearing type electronic device.

With respect to a possible embodiment of the second aspect, wherein the first information is an image, and wherein the ear-wearing type electronic device includes a first imaging device and a second imaging device, and wherein the detecting operation includes capturing the image by the first imaging device such that the captured image does not overlap another image captured by the second imaging device.

With respect to a possible embodiment of the second aspect, the detected information is an approaching object, and the operation includes alerting the user about the approaching object.

With respect to a possible embodiment of the second aspect, the detected information is the user’s gesture, and the operation includes processing associated with the gesture.

With respect to a possible embodiment of the second aspect, the detected information is a location, and the operation includes guidance to a destination.

With respect to a possible embodiment of the second aspect, the detected information is a location, and the operation includes playing a media content associated with the detected location.

With respect to a possible embodiment of the second aspect, the detected information is a location, and the operation includes providing recommendation of contents to the user.

With respect to a possible embodiment of the second aspect, the detected information is a location, and the operation includes:
accessing an external server to acquire information about the detected location; and
providing the user with the acquired information.

With respect to a possible embodiment of the second aspect, the carrying out operation comprises carrying out notification associated with the detected information using a haptic device of the ear-wearing type electronic device.

### BRIEF DESCRIPTION OF DRAWINGS

To describe the technical solutions in the embodiments of the present disclosure or in the background more clearly, the following briefly describes the accompanying drawings for describing the embodiments of the present disclosure or the background in which:

FIG. 1 is a diagram showing an overall structure of an earwear;

FIG. 2 is a diagram showing schematic hardware configuration of an earwear device according to the first embodiment;

FIG. 3 depicts an example system architecture of the earwear of FIG. 2;

FIG. 4 is a world-facing camera’s field of view according to an embodiment;

FIG. 5 is a diagram showing a configuration of an earwear according to an embodiment;

FIG. 6 is a flow diagram showing a method performed by the earwear according to an embodiment;

FIG. 7 is a diagram for explaining a method of user interaction/feedback according to an embodiment;

FIG. 8 is a diagram for explaining a method of user interaction/feedback according to an embodiment;

FIG. 9 is a diagram for explaining a method of user interaction/feedback according to an embodiment;

FIG. 10 is a diagram showing configuration of earwear according to an embodiment;

FIG. 11 is a diagram showing wireless connection between the first and second earwear;

FIG. 12 is a diagram showing hardwire connection between the first and second earwear;

FIG. 13 is a world-facing camera’s fields of view according to an embodiment;

FIG. 14 is a world-facing camera’s fields of view according to an embodiment; and

FIG. 15 is a diagram for explaining a method of user interaction/feedback according to an embodiment.

### DETAILED DESCRIPTION

Some embodiments will now be described more fully hereinafter with reference to the accompanying drawings. It should be understood that the disclosure may be embodied in many different forms and should not be construed as limited to the embodiments set forth herein. Rather, these embodiments are provided such that this disclosure will be thorough and complete, and will fully convey the scope of the disclosure to those skilled in the art. Like numbers refer to like elements throughout. Terms used in the embodiments of this application are merely used to explain embodiments of this application, but are not intended to limit this application.

The following embodiments describe camera-enabled earwear with systems and methods that extend the user’s view, perform real-time and on-board processing of computer vision tasks that understand the user and his/her environment, and has user interaction/feedback based on such understanding when/if needed.

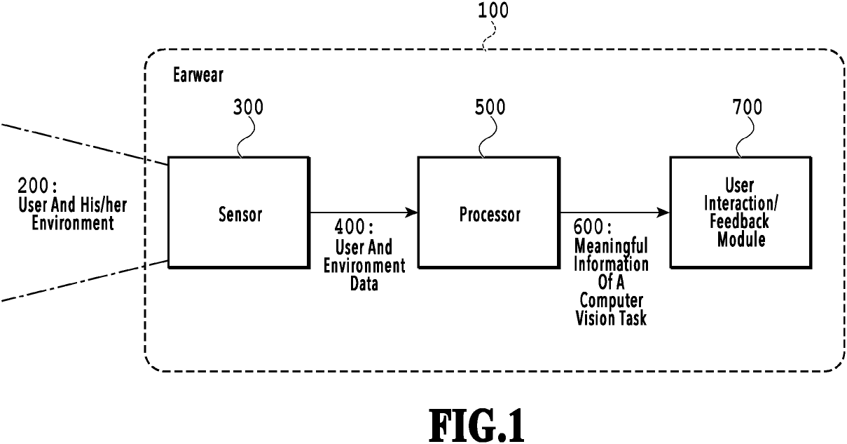

This disclosure provides various types of ear-wearing type electronic devices with extended vision. FIG. 1 is a diagram showing an overall structure of an earwear. An earwear 100 consists of three main modules: a sensor 300, a processor 500 and a user interaction/feedback module 700. The earwear 100 detects the user and his/her environment 200 using a sensor 300. The sensor 300 converts the detected analog data (user and his/her environment 200) into digital data to generate user and environment data 400, and passes on the user and environment data 400 to the processor 500. The processor 500 processes the user and environment data 400 to generate meaningful information of a computer vision task 600. The meaningful information 600 only comprises computer vision metadata for privacy consideration. Here, the computer vision metadata may include information on space in which user exists. Such information may include bounding boxes, semantic segmentation, depth map, etc. Such meaningful information 600 is then used by the user interaction/feedback module 700. The user interaction/feedback module 700 is configured to enable various smart features/functionalities as described below.

### (First Embodiment)

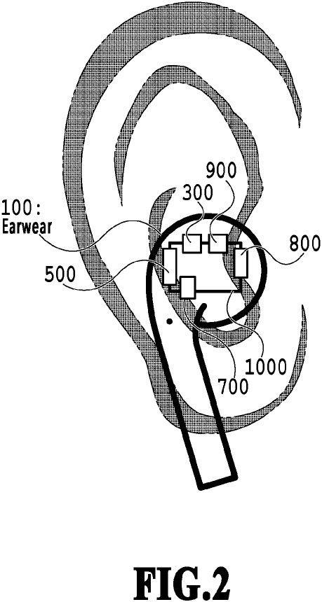

FIG. 2 depicts a diagram showing schematic hardware configuration of an earwear according to the first embodiment. The earwear 100 is an example of an ear-wearing type electronic device, and includes the above-described three main embedded modules: the sensor 300, processor 500 and user interaction/feedback module 700. It also includes additional embedded modules: a memory 800, a power source 900 and a communication unit 1000.

The above-mentioned modules may be formed in any shape within the body of the earwear 100. For example, in particular embodiments, the sensor 300, processor 500 and power source 900 may be formed in one system on a chip (SoC) inside the earwear 100. The SoC combines electronic circuits of computer components onto a single, integrated chip. The SoC may contain analog, digital, mixed-signal or radio frequency functions. Its components usually include a graphical processing unit (GPU), a central processing unit (CPU) and system memory such as random access memory(RAM). Because the SoC includes both the hardware and software, it uses less power, has better performance, requires less space and is more reliable than multi-chip systems. Electronic components in the above mentioned modules may be mounted in the earwear in any suitable manner such that they are sized and shaped to fit securely in the body of the earwear 100. For example, some or all of the electronic components may be partially or fully encased in a suitable material (e.g., polymer such as Epoxy Molding Compound (EMC)) that is shaped to fit in the body of the earwear 100.

### Example System Architecture of the Earwear

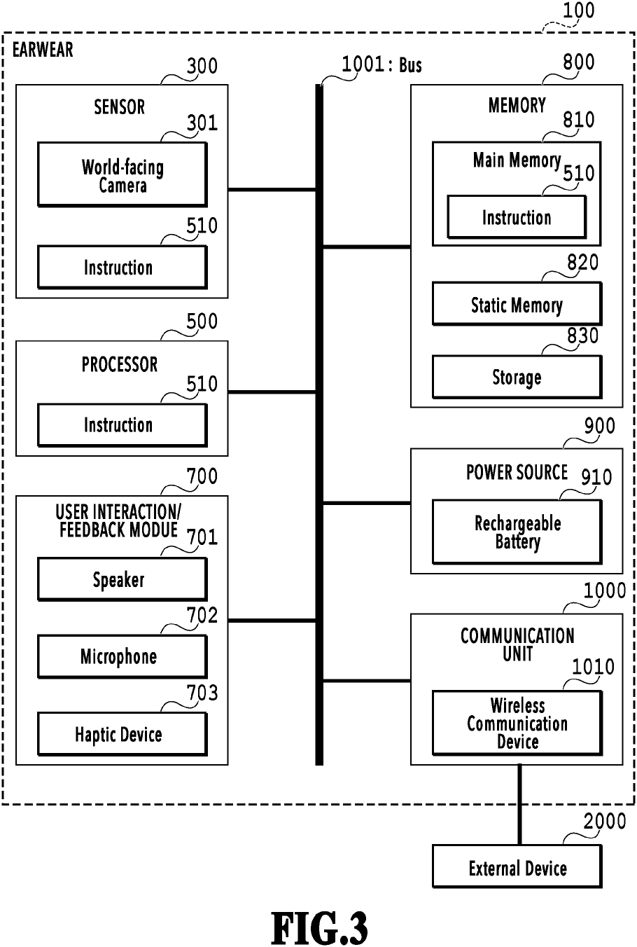

Next, functional configuration of each component of the earwear will be described. FIG. 3 depicts an example system architecture of the earwear of FIG. 2. The earwear 100 includes the sensor 300, processor 500, user interaction/feedback module 700, memory module 800, power source 800 and communication unit 1000, which communicate with each other via a bus 1001.

In some embodiments, the sensor 300 includes at least one world-facing camera 301. The world-facing camera 301 is an imaging device which may be any one of RGB camera, Monochrome camera, Depth camera, Night vision camera, Event camera, Thermal camera, etc. In some embodiments, the sensor 300 may include one or more sets of instructions 510 for instructing the sensor 300 to perform predetermined operations. The instructions may be software for embodying any one or more of methods to detect the user and his/her environment in real-time.

One or more sets of instructions 510 such as software may be included in the processor 500. The one or more sets of instructions 510 embody any one or more of the methods to execute real-time computer vision tasks based on the user and environment data outputted by the sensor 300. Such real-time computer vision tasks may include scene understanding, 3D perception, gesture recognition, object detection, navigation, etc. Also, the one or more sets of instructions 510 embody any one or more of the methods to enable user-earwear interaction via the user interaction/feedback 700.

In some embodiments, the processor 500 may be at least one processing device including, but not limited to, a microprocessor, a central processing unit (CPU), a dedicated ultra-low power Computer Vision Processor based on a custom application specific integrated circuit (ASIC), a field programmable gate array (FPGA), a digital signal processor (DSP), etc.

In some embodiments, the user interaction/feedback module 700 includes input/output signal devices such as a speaker 701, a microphone 702, and a haptic device 703. The haptic device 703 is configured to carry out notification associated with the detected information to by forces, vibration, lights, touch buttons, etc.

In some embodiments, the memory 800 includes a main memory 810, a static memory 820 and a storage device 830 having large-capacity. The static memory 820 is configured based on after flash memory, a non-transitory computer device-accessible storage medium. The main memory 810 may store one or more sets of instructions 510. For example, the main memory 810 may be composed of ROM to store the BIOS, flash memory, DRAM, etc.

In some embodiments, the power source 900 includes a rechargeable battery 910. For example, the rechargeable battery 910 may be any one of alkaline battery, a nickel metal hydride battery, a lithium ion (Li-ion) battery, a lithium ion polymer (Li-ion polymer) battery, a nickel cadmium (NiCd) battery, a Nickel zinc battery, a Nickel-Iron battery, etc.

In some embodiments, the communication unit 1000 includes a wireless communication device 1010 that connects the earwear 100 to the external device 2000 (e.g., another earwear, wearable, mobile phone, tablet, laptop, cloud). The wireless communication device 1010 may be Bluetooth communication module, near field chip, cellular communication module, etc.

Next, function of each module included in the earwear 100 will be described.

### Sensor 300

The sensor 300 includes at least one of world-facing camera 301 and sensors of other types including, but not limited to, a microphone, ear-facing camera, motion sensor, accelerometer, gyroscope, pedometer, global positioning sensor (GPS), impact sensor, respiratory rate sensor, heart rate monitor, electrocardiograms (EKG), thermometer, blood pressure sensor, pulse oximeter, transdermal sensor, blood alcohol concentration (BAC) sensor, olfactory sensor, etc. The at least one world-facing camera may be of any type including, but not limited to, RGB camera, Monochrome camera, Depth camera, the vision camera, Event camera (also known as neuromorphic camera), Thermal camera, etc.

In some embodiments, the one or more sensors 300 are operatively coupled to at least one processor 500.

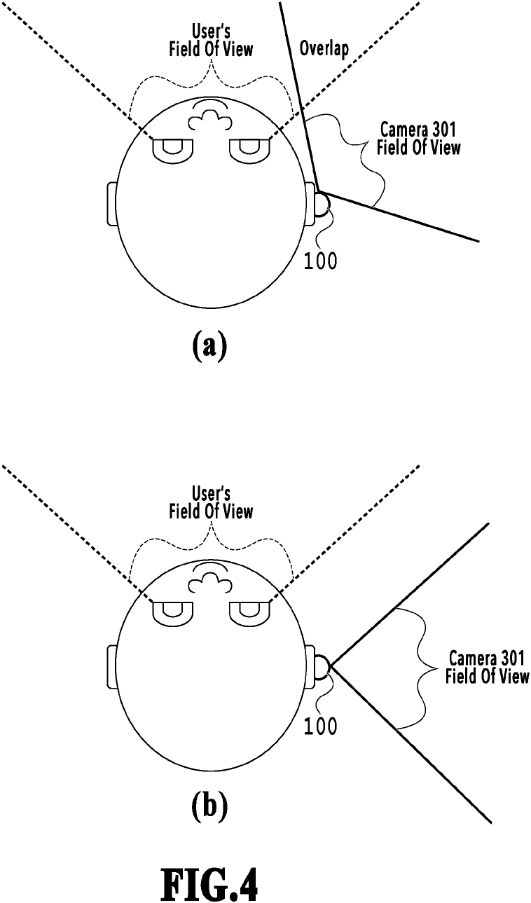

The world-facing camera 301 may have various configurations. In some embodiments, as shown in FIG. 4, the earwear has one single world-facing camera 301. In particular embodiments, the user’s field of view and the world-facing camera’s field of view may have some partial overlap as shown in FIG. 4(a). In particular embodiments, as shown in FIG. 4(b), the user’s field of view and the world-facing camera’s field of view may not have an overlap.

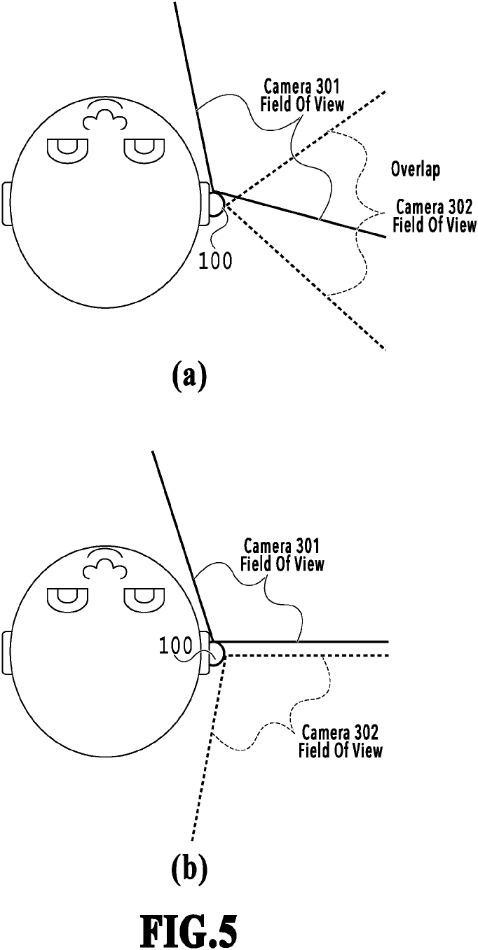

In some embodiments, the sensor 300 includes the first imaging device and the second imaging device. As shown in FIG. 5, the earwear 100 may have a second world-facing camera 302 in addition to the world-facing camera 301 (hereinafter referred to as “the first world-facing camera”). In particular embodiments, as shown in FIG. 5(a), the field of view of the first world-facing camera 301 and the field of view of the second world-facing camera 302 may have some partial overlap. In particular embodiments, the first imaging device captures the image such that the captured image does not overlap another image captured by the second imaging device. As shown in FIG. 5(b), the field of view of the first world-facing camera 301 and the field of view of the second world-facing camera 302 may not have overlap. In some embodiments, the first world-facing camera 301 and the second world-facing camera 302 may be of similar types. For example, both the first world-facing camera 301 and the second world-facing camera 302 are monochrome cameras. In other embodiments, the first world-facing camera 301 and the second world-facing camera 302 may be of different types. For example, the first world-facing camera 301 is monochrome camera and the second world-facing camera 302 is infrared camera.

In some embodiments, the at least one world-facing camera 301 and the sensor 300 detect one or more current physical attributes of the user. Such physical attributes may include, but not limited to, wearer’s heart rate, respiratory rate, brain wave activity, body temperature, blood pressure, oxygen saturation level, movement, gait pattern, head position, user’s speed, etc.

In some embodiments, the at least one of the world-facing camera 301 and the sensor 300 detect one or more characteristics of the environment surrounding the user. The characteristic of the environment may include, for example: the user’s location, a medicine that the user is preparing to take, a food that the user is preparing to eat, an amount of ultraviolet light that the user is subjected to, a smell of an item in close proximity to the user, a proximity of the wearer to a subject (e.g., approaching object such as car, bicycle and people), and an identity of an object associated with the user.

### Processor 500

In some embodiments, the processor 500 includes at least one processing device connected to the sensor 300.

In some embodiments, the processing device may be a general-purpose or specific processing device such as a microprocessor, a central processing unit (CPU), or the like. For example, the processing device may be a vision processing unit. In another example, the processing device may be a dedicated computer vision processor with ultra-low power. It may be constituted based on a custom application specific integrated circuit (ASIC), a field programmable gate array (FPGA), a digital signal processor (DSP) or the like.

In some embodiments, the processor 500 executes one or more sets of instructions 510 for instructing the sensor 300 to perform predetermined operations. The instructions may be software for embodying any one or more of methods such as computer vision tasks or functions such as smart features described herein in real-time. For instance, in the case where the world-facing camera is an event camera, the processor 500 may recognize people and cars from images captured by the event camera in real time using Spiking Neural Networks, which feature massively parallel, low-power and low-latency computation. In other embodiments, in the case where the world-facing camera is a monochrome camera, the processor 500 may perform object detection from the monochrome camera using tiny machine learning such as compressed neural networks in real time, and consuming low power (e.g., under 1 mW). In these cases, the methods performed by the processor 500 are called as computer vision tasks. Also, functions realized by the processor 500 are called as smart features.

### User Interaction/Feedback Module 700

In some embodiments, the user interaction/feedback module 700 includes at least one User Interaction/Feedback interface connected to the processor 500. The interface may be of any type including, but not limited to, a speaker 701, a microphone 702, a haptic device 703. The haptic device 703 is utilized to provide haptic effects to the user. For example, the haptic device 703 can provide haptic effects by forces, vibration, lights, touch buttons, etc.

In some embodiments, the interface may include voice-controlled intelligent personal assistant services. In other embodiments, the user-earwear voice interaction is analyzed locally by the processor 500. In still other embodiments, the interface wirelessly connects the earwear to another device such as another earwear, a wearable, a mobile phone or a cloud based server system. Such server system may include a voice service which allows developers to turn on connected devices with microphones and speakers for voice input, an AI assistant service that enables two-way conversation, a Real-time information provision service in natural language, and an intelligent personal assistant service.

### Memory 800

In some embodiments, the memory 800 includes at least a main memory 810, a static memory 820 and a storage device 830. In some embodiments, the main memory 810 may be of any type including, but not limited to, read-only memory (ROM) to store the BIOS, flash memory, dynamic random access memory (DRAM) (such as synchronous DRAM (SDRAM) or Rambus DRAM (RDPAM) ) . The static memory 820 may be flash memory, static random access memory (SRAM), etc. The storage device 830 is a large-capacity data storage device. The storage device 830 may include a non-transitory computer accessible storage medium. Examples of the non-transitory computer accessible storage medium include, but not limited to, hard drives (HDD), solid-state drive (SSD), flash memory, optical and magnetic media, centralized or distributed database, associated caches and servers, etc.

In some embodiments, the storage device 830 may store one or more sets of instructions 510 for instructing the sensor 300 and processor 500 to perform predetermined methods or functions. The one or more sets of instructions 510 may also reside, completely or at least partially, within the main memory 810 and/or within the processor 500 during execution of the instructions.

### Power Source 900

In some embodiments, the power source 900 includes at least one power source connected to the processor 500 and the sensor 300.

In some embodiments, the power source 900 comprises at least a rechargeable battery 910 such as a rechargeable alkaline battery, a nickel metal hydride (NiMH) battery, a lithium ion (Li-ion) battery, a lithium ion polymer (Li-ion polymer) battery, a nickel cadmium (NiCd) battery, a Nickel zinc battery, a Nickel-Iron battery, or any other suitable rechargeable type battery. In some embodiments, the power source 900 may comprise multiple rechargeable batteries.

In other embodiments, the power source 900 may be recharged by connecting a recharging cable (not shown) into a charging port. The charging port is configured to receive a male portion of a charging cable connector (not shown). In some embodiments, the charging port may take the form of various female connectors such as a micro universal serial bus (USB) female socket, a mini USB female socket, a LIGHTENING® socket, or any other suitable charging configuration.

### Communication Unit 1000

In some embodiments, the communication unit 1000 includes at least one communication device between the earwear 100 and the external device 2000. The external device 2000 may be another earwear, wearable, mobile phone, tablet, laptop, or cloud computing system. In some embodiments, the communication device includes a bus 1001 that communicates with the other components of the earwear (i.e., the sensor 300, processor 500, user interaction/feedback module 700, memory 800 and power source 900) . The communication unit 1000 can also include a wireless communication device 1010 of any type including, but not limited to, Bluetooth communication module, near field chip, cellular communication module, etc.

It should be noted that the components in the earwear 100 are not limited to the above description. For example, each component can be configured by multiple hardware components, software components or combination of hardware and software components.

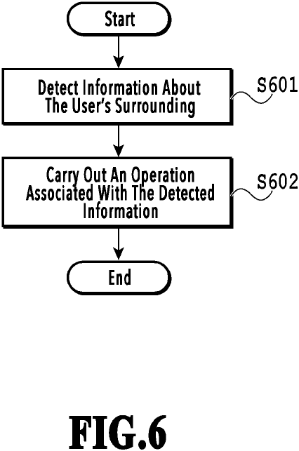

Next, a method performed by the earwear will be described with reference to FIG. 6.

In operation S601, the sensor 300 detects information about the user’s surrounding. This information is analog data including a user and his/her environment 200. The detected information includes information about an area beyond a field of view of the user. The sensor 300 generates digital data (user and environment data) 400 based on the detected information about the user and his/her environment 200. The user and environment data 400 is transmitted to the processor 500.

In operation S602, the processor 500 generates meaningful information of a computer vision task 600 based on the received user and environment data 400. The generated data constitutes a computer vision task which is transmitted to the user interaction/feedback module 700. The user interaction/feedback module 700 carries out an operation associated with the detected information.

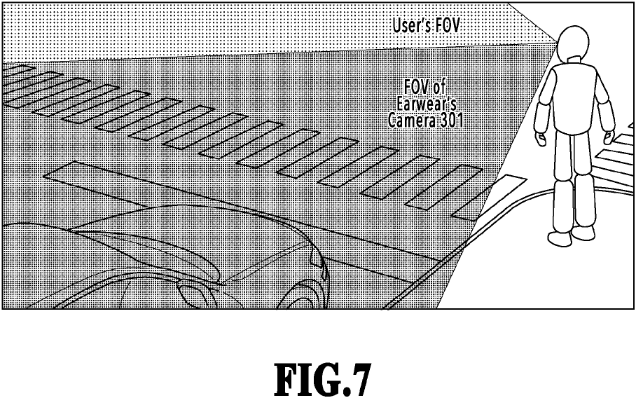

Next, with reference to FIGS. 7 to 9, example methods of user interaction/feedback will be described.

The earwear opens new avenues of usage case scenarios. One usage scenario may be smart walking.

In some embodiments, the user interaction/feedback module 700 responds to the computer vision tasks performed by the processor 500 and sensor 300. For example, as shown in FIG. 7, if the earwear 100 detects a nearby car within the field of view (FOV) of the world-facing camera 301, it may notify/alert the user about it via the user interaction/feedback module 700. In FIG. 7, detection of the nearby car may be recognized by the processor 500 based on the difference between the frames of the image captured by the world-facing camera 301. In some embodiments, the car is detected using the world-facing camera 301 and the processor 500 based on convolutional networks. In some embodiments, it is possible to use a Doppler sensor for detecting the nearby car as the sensor 300.

In some embodiments, the notification or alert may include audio tone or vibration. Then, the user may stop the alert by voice command detected by the microphone 702 or tactile input detected by the haptic device 703. According to the embodiment in FIG. 7, the earwear may interact with the user (e.g., a pedestrian wearing the earwear 100) by alerting him/her when there’s a nearby car detected by the computer vision task. Because the user has limited vision, there is a risk that the cars are out of the user’s field of view. The present embodiment is useful to avoid road accidents when the user is distracted or unaware of the surroundings.

In some embodiments, the earwear 100 interacts with the user by detecting gestures of the user using the world-facing camera 301, the processor 500 and a tiny machine learning software. In some embodiments, the earwear 100 may identify a gesture performed by the user and perform a function associated with the gesture. In particular embodiments, the earwear 100 may be configured to perform a particular function in response to identifying a particular gesture, where the particular gesture is associated with the particular function.

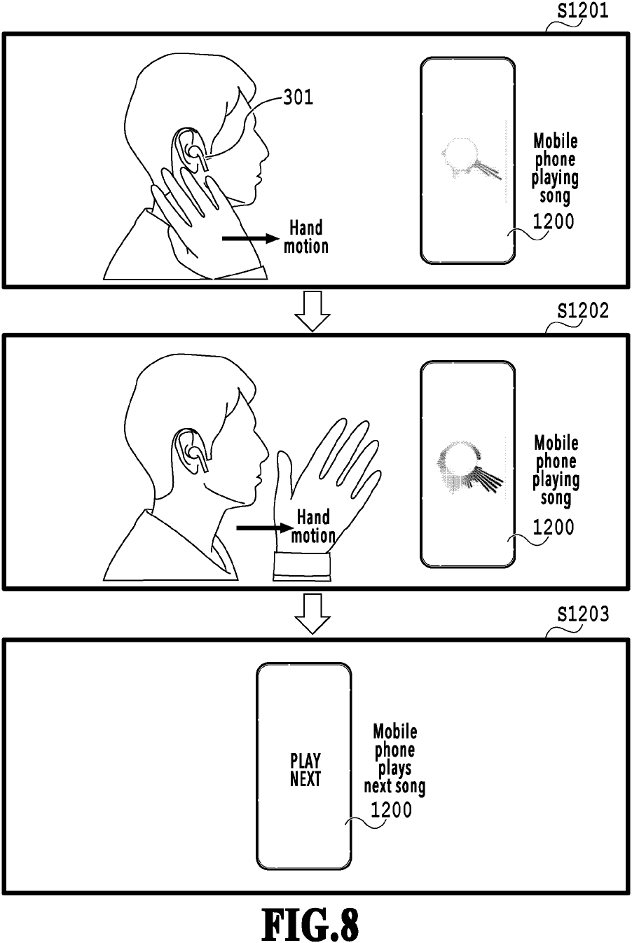

Another usage case scenario may enhance listening experience. FIG. 8 is a diagram for explaining an example method of performing a particular function. In FIG. 8, the earwear 100 is connected to a mobile phone 1200, and the user is listening to some music from the mobile phone 1200 via the earwear 100 (S1201). In this case, the mobile phone 1200 is running a music application. Then, the user may control the music application to play the next song by performing some hand gesture (S1202). In FIG. 8, the gesture is hand motion from back to forward in front of the world-facing camera 301. The communication unit 1000 sends instruction to play the next music to the mobile phone 1200 (S1203). Then, the mobile phone 1200 plays the next music in response to the received instruction. Accordingly, it is possible to cause the external device (e.g., the mobile phone) to perform the particular function without directly operating the mobile phone 1200 or touching the earwear 100.

The computer vision tasks may provide meaningful information such as the user’s gestures or the scene’s characteristics to the earwear 100. The earwear 100 may use such information to enable new gesture controls without touch operation, as in FIG. 8.

In FIG. 8, the front-back movement of the hand may be recognized based on the difference between the frames of the image captured by the world-facing camera 301. In some embodiments, the processor 500 may recognize hand movements by executing a hand tracking algorithm. It should be noted that the movement of the hand is not limited to motion in one direction. For example, it may be possible to input a command to the earwear 100 using a sign language to input instructions to the processor 500.

In some embodiments, the earwear 100 may also interact with the user by recognizing the characteristics of the environment surrounding the user using the world-facing camera 301, the processor 500 and a tiny machine learning software.

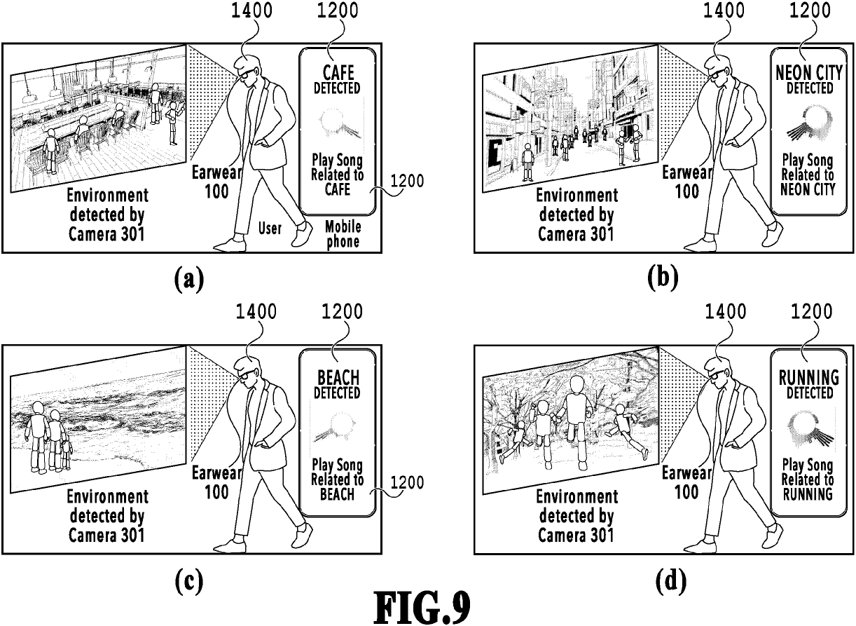

The earwear may also help and guide the user to navigate. FIG. 9 is diagrams for explaining example interaction with the user. For instance, in cases where the earwear 100 is connected to the mobile phone 1200, and the user is listening to some music from the mobile phone 1200 via the earwear 100, the earwear 100 may recommend some media content (e.g., a song that relates to the scene characteristic) to the user based on the recognized characteristics of the environment. As shown in FIG. 9(a), the user’s environment is a cafe. The world-facing camera 301 detects such environment and the processor 500 recognizes the scene based on the detected environment. In this case, the meaningful information 600 is “cafe detected.” This meaningful information 600 triggers a recommendation functionality that causes the mobile phone 1200 to play a song related to a cafe. Similar recommendation functionalities may be executed by the earwear 100 for other scenes such as neon city as shown in FIG. 9(b), beach as shown in FIG. 9(c), and running as shown in FIG. 9(d).

According to the above embodiments in FIG. 9, the earwear may use meaningful information such as the user’s gestures in order to recommend media content to the user based on the detected characteristics of the environment. In this case, the earwear may take the following operations:
accessing an external server to acquire information (media content) about the detected gesture; and
providing the user with the acquired information.

Also, the earwear may use meaningful information such as the scene’s characteristics in order to recommend media content to the user based on the detected characteristics of the environment. In this case, the earwear may take the following operations:
accessing the external server to acquire information (media content) about the detected location; and
providing the user with the acquired information.

### Second Embodiment

In the second embodiment of the present disclosure, the earwear 100 may be used with another earwear. For the purpose of easy and clear understanding, only certain parts will be discussed to highlight the differences in the structure and operation of the second embodiment as compared to the first embodiment.

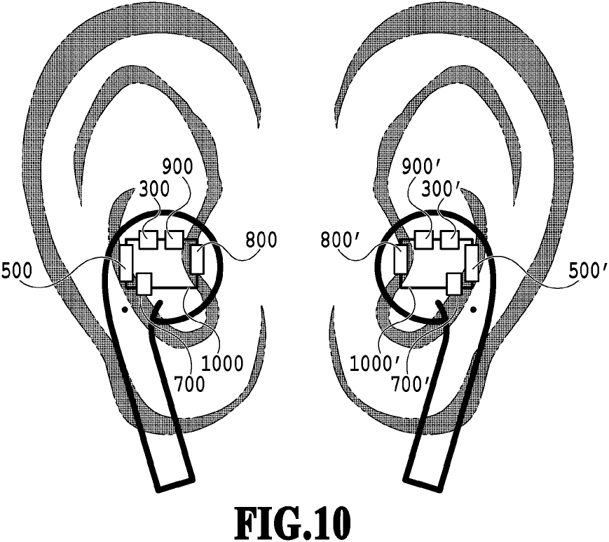

In the present embodiment, the earwear 100 (also referred to as the first earwear herein) may be used together with the second earwear 100′ as shown in FIG. 10. In this case, shapes of the earwear 100 and 100′ are symmetrical to each other. The earwear 100′ mirrors modules and functions of the earwear 100. Similar to the first earwear 100 shown in FIG. 2, the second earwear 100′ includes the same three main embedded modules: a sensor 300′, a processor 500′ and UI/feedback module 700′. The second earwear 100′ also includes an additional embedded memory 800′, a power source 900′ and a communication unit 1000′ corresponding to the memory 800, power source 900 and communication unit 1000.

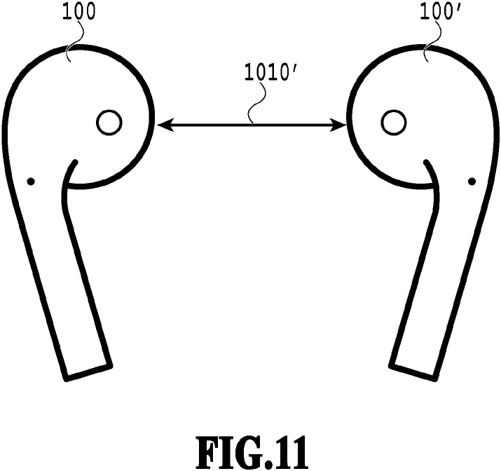

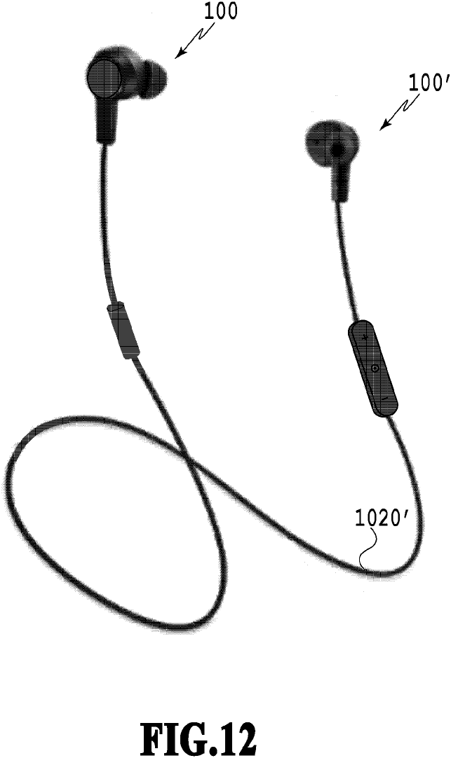

The first and second earwear may be connected in various ways. In some embodiments, the second earwear 100′ may be operatively coupled to the first earwear 100 via a wireless connection 1010′ as shown in FIG. 11. The wireless connection 1010′ may be WiFi, Bluetooth, near-field communications, etc. In other embodiments depicted in FIG. 12, the second earwear 100′ may be operatively coupled to the first earwear 100 via a hardwire connection 1020′. The hardwire connection may be fixed or removable. For example, the hardwire connection may be carried out by connecting the charging port of the first earwear 100 and the charging port of the second earwear 100′. In particular embodiments, the second earwear 100′ may be configured by the user to be operatively coupled to the first earwear 100 by either wireless connection or hardwire connection.

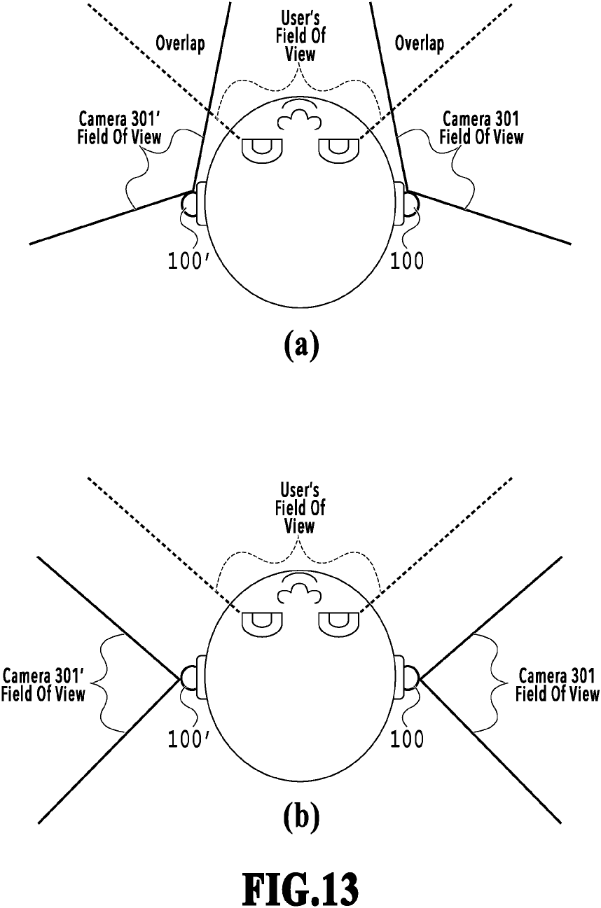

In some embodiments where the first world-facing earwear 100 and the second world-facing earwear 100′ are identical, the first world-facing camera 301 and the second world-facing camera 301′ may have various configurations. In some embodiments, as shown in FIG. 13, each of the earwear 100 and the earwear 100′ has a single world-facing camera 301 or 301′, respectively. In particular embodiments, as shown in FIG. 13(a), the user’s field of view and the field of view of the first world-facing camera 301 and 301′ may have some partial overlap. In particular embodiments, as shown in FIG. 13(b), the user’s field of view and the field of view of the first world-facing camera 301 and the second world-facing camera 301′ may not have an overlap.

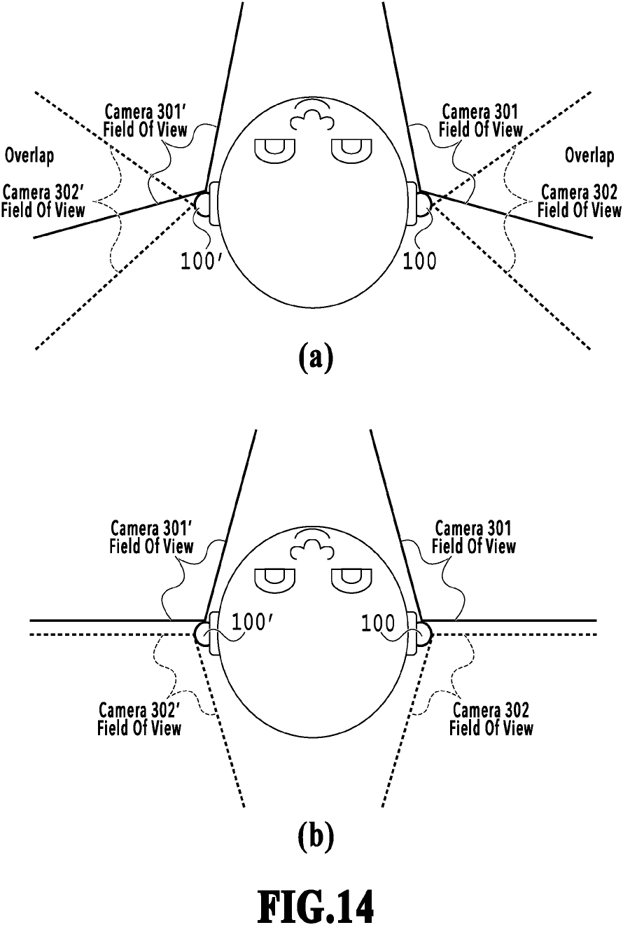

In some such embodiments where the first earwear 100 and second earwear 100′ are identical, the second earwear 100′ may have a second world-facing camera 302′ in addition to the second world-facing camera 301′ as depicted in FIG. 14. In particular embodiments, as shown in FIG. 14(a), the field of view of the second world-facing camera 301′ and the field of view of the second world-facing camera 302′ may have some partial overlap. In particular embodiments, as shown in FIG. 14(b), the field of view of the second world-facing camera 301′ and the field of view of the second world-facing camera 302′ may not have overlap. In some embodiments, the second world-facing camera 301′ and the second world-facing camera 302′ may be of similar types. For example, both the second world-facing camera 301′ and the second world-facing camera 302′ may be monochrome cameras. In other embodiments, the second world-facing camera 301′ and the second world-facing camera 302′ may be of different types. For example, the second world-facing camera 301′ is monochrome and the second world-facing camera 302′ is infrared camera.

In some embodiments, the second earwear 100′ may be different in shape, modules and/or functions from that of the first earwear 100. For example, in some embodiments, the second earwear 100′ may be smaller, lighter, or made from a different material as compared to the first earwear 100. Moreover, depending on the application of the earwear, the first and second earwear may have different module configurations.

The user interaction/feedback module 700′ of the second earwear 100′ may be similar to the user interaction/feedback module 700 explained for the first earwear 100.

In some embodiments, the second embodiment of the earwear may recognize gestures executed by the user’s left and right hands and enable interaction with the user in real time.

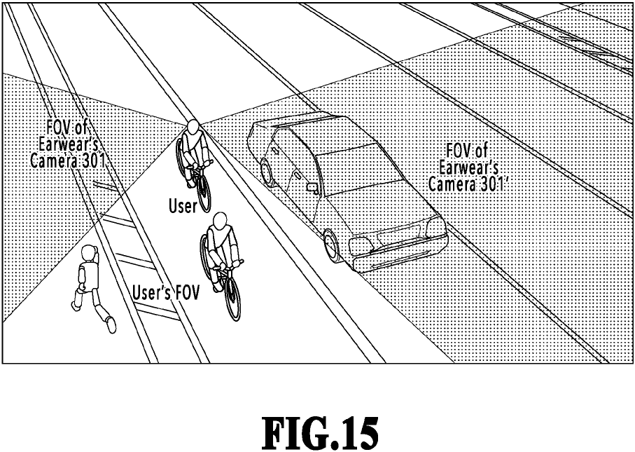

Another usage scenario may be smart walking and cycling. For example, as shown in FIG. 15, the earwear may interact with the user (e.g., a cyclist wearing the earwear 100) by alerting him/her when there’s a nearby car detected by the computer vision task. FIG. 15 is a diagram for explaining example methods of user interaction/feedback. As shown in FIG. 15, the first world-facing camera 301 and the second world-facing camera 301′ may alert a cyclist wearing the earwear 100 if nearby cars are detected and recognized by the earwear 100 or 100′.

The benefit of this disclosure includes privacy protection handling. The computation of the user’s data and his/her environment’s data is processed entirely in the earwear. The processor executing the computer vision task in the earwear outputs meaningful information (i.e., metadata) that is used to enable further user-earwear interaction/feedback. This means sensitive information is not stored or shared, making this earwear more secure compared to wearables that rely on data transfer and external devices for such computations.

Although various embodiments are described above, many modifications and other embodiments of the disclosure will come to mind to one skilled in the art to which this disclosure pertains having the benefit of the teachings presented in the foregoing descriptions and the associated drawings.

As will be understood by one skilled in the relevant field in light of this disclosure, the disclosure may take form in a variety of different mechanical and operational configurations. For example, the earwear described in these embodiments may include any other suitable earwear, such as, for example, headphones. Moreover, in some embodiments, the computer vision tasks performed by the earwear may communicate with other devices (e.g., earwear, other earwear, wearables, smart phone, tablet, laptop, PC, cloud) to enable enhanced computer vision tasks such as scene recognition and/or guidance such as navigation enhanced with data coming from an external server. In addition, in some embodiments, the processor executing the computer vision tasks may be a processor with a dedicated architecture such as a tiny Artificial Intelligence (AI) architecture. Finally, the earwear according to the present disclosure may have any type of functionalities and usage case scenarios other than the ones described herein (e.g., enhanced gesture recognition, smart walking and cycling, scene-aware content recommendation).

Therefore, it is to be understood that the present disclosure is not to be limited to the embodiments disclosed herein, and that the modifications and other embodiments are intended to be included within the scope of the appended example concepts. Although specific terms are employed herein, they are used in a generic and descriptive sense only and not for the purposes of limitation.

1. An electronic device configured to be worn on an ear of a user, the electronic device comprising:
a sensor configured to detect first information about a surrounding of the user, the first information including second information about an area beyond a field of view of the user; and
a processing unit configured to carry out an operation associated with the first information.

2. The electronic device according to claim 1, further comprising:
a communication device configured to communicate with another electronic device.

3. The electronic device according to claim 2, wherein the first information comprises an image, and wherein the sensor includes a first imaging device and a second imaging device, and wherein the first imaging device is configured to capture the image such that the captured image does not overlap another image captured by the second imaging device.

4. The electronic device according to claim 1, wherein the first information comprises an approaching object, and wherein the operation includes alerting the user about the approaching object.

5. The electronic device according to claim 1, wherein the first information comprises a gesture of the user, and wherein the operation includes processing associated with the gesture.

6. The electronic device according to claim 1, wherein the first information comprises a location, and wherein the operation includes guidance to a destination.

7. The electronic device according to claim 1, wherein the first information comprises a location, and wherein the operation includes playing a media content associated with the location.

8. The electronic device according to claim 1, wherein the first information comprises a location, and wherein the operation includes providing a recommendation of content to the user.

9. The electronic device according to claim 1, wherein the first information comprises a location, and wherein the operation includes:
accessing an external server to acquire information about the location; and
providing the user with the acquired information.

10. The electronic device according to claim 1, further comprising a haptic device configured to carry out a notification associated with the first information.

11. A method performed by an electronic device that is configured to be worn on an ear of a user, the method comprising:
detecting first information about a surrounding of the user, the first information including second information about an area beyond a field of view of a user; and
carrying out an operation associated with the first information.

12. The method according to claim 11, wherein detecting the first information comprises:
communicating with another electronic device.

13. The method according to claim 12, wherein the first information comprises an image, wherein the electronic device comprises a first imaging device and a second imaging device, and wherein detecting the first information comprises capturing the image by the first imaging device such that the captured image does not overlap another image captured by the second imaging device.

14. The method according to claim 11, wherein the first information comprises an approaching object, and wherein the operation includes alerting the user about the approaching object.

15. The method according to claim 11, wherein the first information comprises a gesture of the user, and wherein the operation includes processing associated with the gesture.

16. The method according to claim 11, wherein the first information comprises a location, and wherein the operation includes guidance to a destination.

17. The method according to claim 11, wherein the first information comprises a location, and wherein the operation includes playing a media content associated with the location.

18. The method according to claim 11, wherein the first information comprises a location, and wherein the operation includes providing a recommendation of content to the user.

19. The method according to claim 11, wherein the first information comprises a location, and wherein the operation includes:
accessing an external server to acquire information about the location; and
providing the user with the acquired information.

20. The method according to claim 11, wherein carrying out the operation associated with the first information comprises carrying out a notification associated with the first information using a haptic device of the electronic device.
